(19) United States
(12) Patent Application Publication
(10) Pub. No.: US 2019/0313007 A1
(43) Pub. Date: Oct. 10, 2019

(54) INFRARED CAMERA MODULE, IMAGE SENSOR THEREOF, AND ELECTRONIC DEVICE

(71) Applicant: Samsung Electro-Mechanics Co., Ltd., Suwon-si (KR)

(72) Inventor: Hyun KIM, Suwon-si (KR)

(73) Assignee: Samsung Electro-Mechanics Co., Ltd., Suwon-si (KR)

(21) Appl. No.: 16/161,122

(22) Filed: Oct. 16, 2018

(30) Foreign Application Priority Data
Apr. 6, 2018 (KR) 10-2018-0040372

(51) Int. Cl. H04N 5/232; G02B 5/20; G02B 7/09; G03B 11/00; G03B 5/02; G01S 17/10; G01S 7/481; H04N 5/33

(52) U.S. Cl. CPC H04N 5/23212; G02B 5/208; G02B 7/09; G03B 11/00; G03B 2205/0046; G01S 17/10; G01S 7/4816; H04N 5/33; G03B 5/02

(57) ABSTRACT

An infrared camera module includes a lens configured to focus by refracting light, a filter configured to allow a light with its wavelength in an infrared band, incident on the lens, to pass therethrough, an image sensor configured to generate distance information to an object based on the light with its wavelength in an infrared band, and an actuator configured to drive the lens in one direction and to adjust a focal distance of the lens.

### CROSS-REFERENCE TO RELATED APPLICATION(S)

This application claims benefit of priority to Korean Patent Application No. 10-2018-0040372 filed on Apr. 6, 2018 in the Korean Intellectual Property Office, the disclosure of which is incorporated herein by reference in its entirety.

### BACKGROUND

### 1. Field

The present disclosure relates to an infrared camera module, an image sensor thereof, and an electronic device.

### 2. Description of Related Art

To recognize a distance to an object in a space, a time of flight (TOF) infrared camera is used. A TOF infrared camera has a TOF sensor configured to calculate a distance to an object on the basis of the time taken for light emitted from an infrared light source to be reflected from the object and to return to the camera. Generally, a TOF infrared camera focuses on a certain point and receives light reflected from an object.

However, recently, a TOF infrared camera has been variously applied in augmented reality, to a Bokeh technique of highlighting an object, to a 3D rendering technique of scanning an object and displaying an object image in three dimensions, to a user recognition technique of extracting features of a user's face and authenticating a user, and the like. Accordingly, it has become necessary to change a focal distance of a TOF infrared camera.

### SUMMARY

An aspect of the present disclosure is to provide an infrared camera module, an image sensor thereof, and an electronic device capable of changing a focal distance.

According to an aspect of the present disclosure, an infrared camera module includes a lens configured to focus by refracting light, a filter configured to allow a light with its wavelength in an infrared band, incident on the lens, to pass therethrough, an image sensor configured to generate distance information to an object based on the light with its wavelength in an infrared band, and an actuator configured to drive the lens in one direction and to adjust a focal distance of the lens.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a conceptual diagram illustrating a distance measuring method of an infrared camera module, according to an exemplary embodiment in the present disclosure;

FIG. 2 is a cross-sectional diagram illustrating an infrared camera module according to an exemplary embodiment in the present disclosure;

FIG. 3 is a block diagram illustrating a main portion of an electronic device according to an exemplary embodiment in the present disclosure;

FIG. 4 is a block diagram illustrating a main portion of an electronic device according to another exemplary embodiment in the present disclosure; and

FIG. 5 is a block diagram of a main portion of an electronic device according to another exemplary embodiment in the present disclosure.

### DETAILED DESCRIPTION

Hereinafter, embodiments of the present disclosure will be described as follows with reference to the attached drawings. These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another exemplary embodiment without departing from the spirit and scope of the present disclosure. Further, modifications of positions or arrangements of elements in exemplary embodiments may be made without departing from the spirit and scope of the present disclosure. The following detailed description is, therefore, not to be taken in a limiting sense, and the scope of the present invention is defined only by appended claims, appropriately interpreted, along with the full range of equivalents to which the claims are entitled. In the drawings, the same elements will be indicated by the same reference numerals.

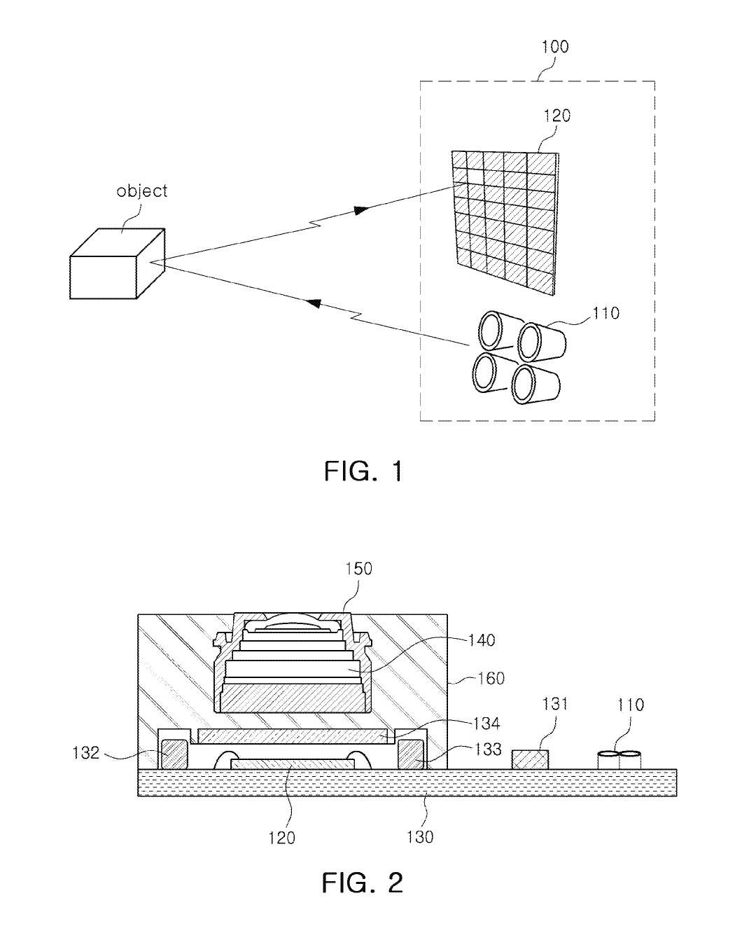

FIG. 1 is a conceptual diagram illustrating a distance measuring method of an infrared camera module according to an exemplary embodiment.

Referring to FIG. 1, an infrared camera module 100 according to an example may include a light output portion 110 outputting light and an image sensor 120.

The light output portion 110 may irradiate pulsed light having a predetermined period on an object. The light irradiated on the object may be reflected from the object and provided to the image sensor 120. The light output portion 110 may include at least one light source, and the light source may include one of a laser diode (LD), a light emitting diode (LED), and a vertical cavity surface emitting laser (VCSEL). The light output from the light output portion 110 may have a wavelength of infrared band. Depending on examples, a guide member guiding a path of light may be arranged in a front portion of the light output portion 110, and the pulsed light irradiated from the light output portion 110 may be irradiated to the object at a target angle through the guide member.

The image sensor 120 may receive the pulsed light reflected from the object. The image sensor 120 may generate distance information between the light output portion 110 and the object on the basis of the received light reflected from the object. For example, the image sensor 120 may calculate a distance between the light output portion 110 and the object on the basis of a delayed time of the light reflected from the object.

The image sensor 120 may include a pixel array comprising a plurality of pixels. The plurality of pixels may be arranged in matrix form. A circuit for generating distance information between the light output portion 110 and the object may be embedded in each of the plurality of pixels of the pixel array, and the distance information between the light output portion 110 and the object may be generated in each of the plurality of pixels. The image sensor 120 may calculate the distance information in depth map form in accordance with the distance information output from the plurality of pixels arranged in matrix form.

According to the example, a plurality of the distance information generating circuits may be separately arranged externally of the plurality of pixels, and the distance information generating circuits may be connected to the plurality of pixels. The distance information generating circuits may generate a plurality of pieces of distance information on the basis of light received in the plurality of pixels.

FIG. 2 is a cross-sectional diagram illustrating an infrared camera module according to an exemplary embodiment.

A light output portion 110 and an image sensor 120 in an infrared camera module in the example in FIG. 2 may be the same as the light output portion 110 and the image sensor 120 in the infrared camera module in the example in FIG. 1, and thus, overlapped descriptions thereof will not be repeated.

Referring to FIG. 2, the infrared camera module 100 may include a light output portion 110, an image sensor 120, a substrate 130, a lens module 140, a lens barrel 150, and an actuator 160.

The light output portion 110 may be arranged on the substrate 130 in the infrared camera module 100. However, depending on examples, the light output portion 110 may also be arranged in one portion of an electronic device in which the infrared camera module is employed.

The image sensor 120 may be mounted on the substrate 130. For example, the image sensor 120 may be mounted on the substrate 130 by a chip-on-board method. A bonding pad may be arranged in an upper portion of the image sensor 120 to implement the chip-on-board method, and the bonding pad may be electrically connected to the substrate 130 through a wire.

The substrate 130 may be implemented as at least one of a rigid printed circuit board and a flexible printed circuit board. For example, the substrate 130 may include a via formed in a thickness direction of the substrate 130 and a circuit pattern arranged on one surface of the substrate 130. The via and the circuit pattern on the substrate 130 may provide an electrical connection path.

The substrate 130 may be electrically connected to a wire of the image sensor 120 through the circuit pattern, and the substrate 130 may also be electrically connected to a host of the electronic device in which the infrared camera module is employed through the circuit pattern. In other words, through the substrate 130, the image sensor 120 and the host of the electronic device may be electronically connected to each other.

A memory 131 may be arranged in one surface of the substrate 130. For example, the memory 131 may include an electrically erasable programmable read-only memory (EEPROM). Depending on examples, the memory 130 may be embedded in the substrate 130, and the memory 131 may be electrically connected to the image sensor 120 through the via on the substrate 130.

An integrated circuit 132 and a passive device 133 may be mounted on the substrate 130 along with the image sensor 120. For example, the integrated circuit 132 may include a driver IC and a hole device for driving the actuator 160, and the passive device 133 may include a capacitor for a noise filtering of a power terminal of the image sensor 120.

A filter 134 may be disposed between the lens module 140 and the image sensor 120. The filter 134 may include an IR filter, and the IR filter may allow light of a predetermined infrared wavelength band incident to the image sensor 120 to pass through. For example, the IR filter may allow light of an infrared band of 850 nm to 940 nm to pass therethrough.

The lens module may include at least one lens. The lens may allow light reflected from an object to pass therethrough. Light may be refracted by the lens to have a focus. For example, the lens may include an infrared lens, and the infrared lens may include a plastic injection lens or a lens processed by a precision glass molding. Depending on examples, an infrared penetration window may be disposed in a front portion of the lens module 140 to protect the lens. The infrared penetration window may be formed of a material such as CaF2, BaF2, polyethylene, and the like.

The lens barrel 150 may have the lens module 140 embedded therein. The lens barrel 150 may move in one direction, that is, in an optical direction, along with the lens module 140. To this end, one of a driving magnet and a driving coil may be arranged in one portion of the lens barrel 150 opposing the actuator 160.

The actuator 160 may accommodate the lens barrel 150, and may drive the lens barrel 150 in one direction to adjust a focal distance of the lens provided in the lens module 140.

The actuator 160 may include one of a voice coil motor actuator (VCM), a surface memory alloy (SMA) actuator, a piezo actuator, and a liquid lens actuator.

For example, the actuator 160 may include the driving magnet and the driving coil disposed to oppose the driving magnet, which are attached to one portion of the lens barrel 150. However, depending on examples, the positions of the driving magnet and the driving coil may be switched with each other. Specifically, the driving coil may be arranged in one portion of the lens barrel 150, and the driving magnet may be disposed to oppose the driving coil.

The actuator 160 may apply a driving signal to the driving coil opposing the driving magnet and drive the lens module 140 in an optical axis direction, thereby adjusting a focal distance of the lens provided in the lens module 140.

In the case in which a focus of the lens provided in the lens module 140 is fixed, the light reflected from an object may not be properly provided to the image sensor 120. For example, in the case in which a focus of the lens is set to correspond to an object at short distance, but an actual object is located at long distance, or in the case in which a focus of the lens is set to correspond to an object at long distance, but an actual object is located at short distance, light reflected from the object may not be properly provided to the image sensor 120. In this case, infrared rays reflected from the object by a certain distance may be dispersed throughout several or several tens of pixels of the image sensor 120, and a resolution of distance information of an image may be significantly degraded. For instance, in the case of an image sensor having a VGA level of resolution, if a focus of a lens is properly set, VGA level of distance information may be obtained, but if the lens is out of focus, distance information of a low resolution, such as a ¼, 1/9, and the like, lowered resolution from the VGA level resolution, may be obtained. Particularly, an accuracy of distance information calculation around an edge of the object may be significantly degraded.

The actuator 160 according to the example may improve a resolution by adjusting a focal distance of the lens provided in the lens module 140.

The actuator 160 may determine a focal distance of the lens module 140 depending on an operational mode of the infrared camera module. The operational mode may be transmitted to the infrared camera module by the host of the electronic device in which the infrared camera module is employed. For example, when a user executes an application corresponding to each mode, a focal distance of the infrared camera module may be changed. The operational mode may include at least two operational modes, and different focal distances may be determined depending on at least two operational modes.

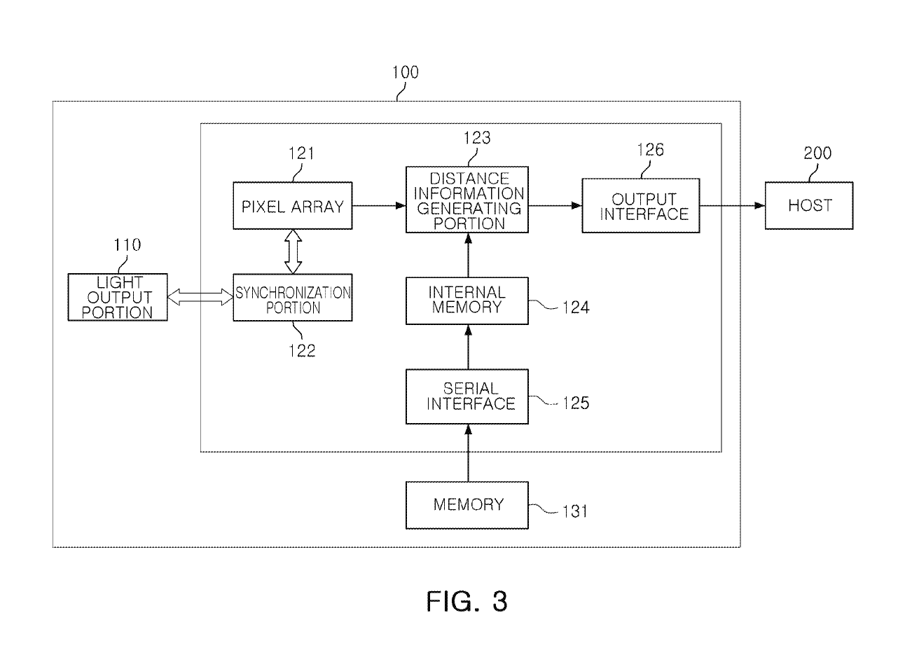

FIG. 3 is a block diagram illustrating a main portion of an electronic device according to an exemplary embodiment.

Referring to FIG. 3, an electronic device according to an example may include an infrared camera module 100 and a host 200.

An image sensor 120 may include a pixel array 212, a synchronization portion 122, a distance information generating portion 123, an internal memory 124, a serial interface 125, and an output interface 126.

The pixel array 121 may include a plurality of pixels disposed in matrix form. The plurality of pixels may receive light reflected from an object. The synchronization portion 122 may synchronize a light source provided in a light output portion 110 and an operation of the pixel array 121. For example, the synchronization portion 122 may synchronize a light irradiation timing of the light source provided in the light output portion 110 and a timing of operation of the pixel array being turned on.

The distance information generating portion 123 may be connected to each of the plurality of pixels of the pixel array 121. The distance information generating portion 123 may include a plurality of distance information generating circuits connected to the plurality of pixels. The plurality of distance information generating circuits may calculate a plurality of pieces of distance information on the basis of light received in the plurality of pixels.

In FIG. 3, the distance information generating portion 123 is illustrated as a separate component from the pixel array 121, but depending on examples, the distance information generating circuit may be provided in each of the pixel arrays 121 to calculate distance information.

The distance information generating portion 123 may apply a correction parameter to correct the calculated distance information. The correction parameter may include a plurality of correction parameters having different values, and the plurality of correction parameters may be allocated in a plurality of operational modes of the infrared camera module, respectively.

The distance information generating portion 123 may apply the correction parameter allocated in a certain operational mode to distance information calculated in the operational mode and correct the calculated distance information.

For example, in the case that the operational mode is divided into a first mode, a long distance mode, and a second mode, a short distance mode, the correction parameter allocated in the first mode may be applied to distance information calculated when the first is executed, and a correction parameter allocated in the second mode may be applied to distance information calculated when the second mode is executed. The correction parameter may be a parameter for calculating distance information of a high resolution by adjusting a distance between the lens and the image sensor which changes depending on an operational mode.

The correction parameter may be stored in a memory 131 external of the image sensor 120 and provided. When an application corresponding to each of modes is executed, the correction parameter stored in the memory 131 may be loaded into the internal memory 124 through the serial interface 125, and the distance information generating portion 123 may refer to the correction parameter. For example, the internal memory 124 may include a static random access memory (SRAM). The distance information ultimately generated in the distance information generating portion 123 may be provided to the host 200 of the electronic device through the output interface 126.

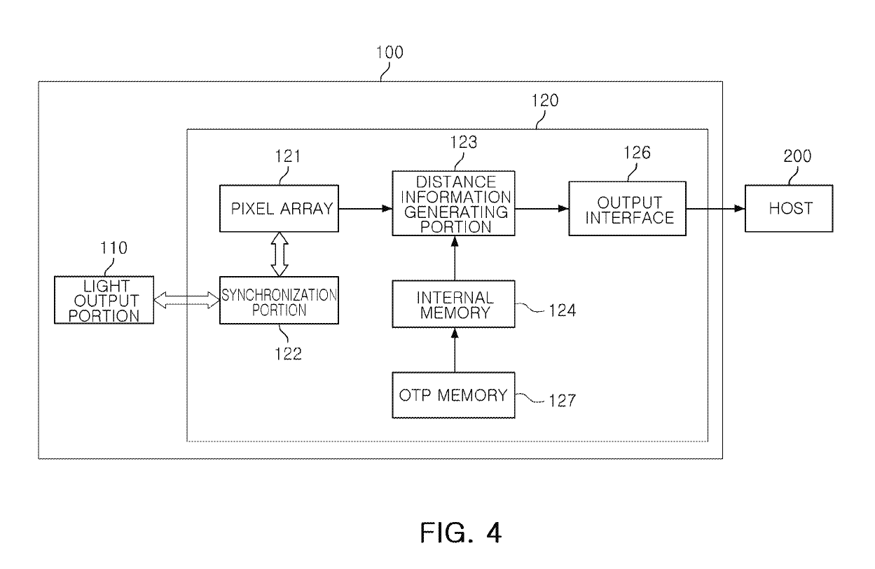

FIG. 4 is a block diagram illustrating a main portion of an electronic device according to another exemplary embodiment.

An electronic device according to the example in FIG. 4 is the same as the electronic device in the example in FIG. 3, and thus, overlapped descriptions thereof will not be repeated, and differences will mainly be described.

Referring to FIG. 4, an image sensor 120 may include a pixel array 121, a synchronization portion 122, a distance information generating portion 123, an internal memory 124, an output interface 126, and a one-time programmable (OTP) memory 127.

A correction parameter may be stored in the OTP memory 127 of the image sensor 120. When an application corresponding to each of modes is executed, the correction parameter stored in the OTP memory may be loaded to the internal memory 124, and the distance information generating portion 123 may refer to the correction parameter.

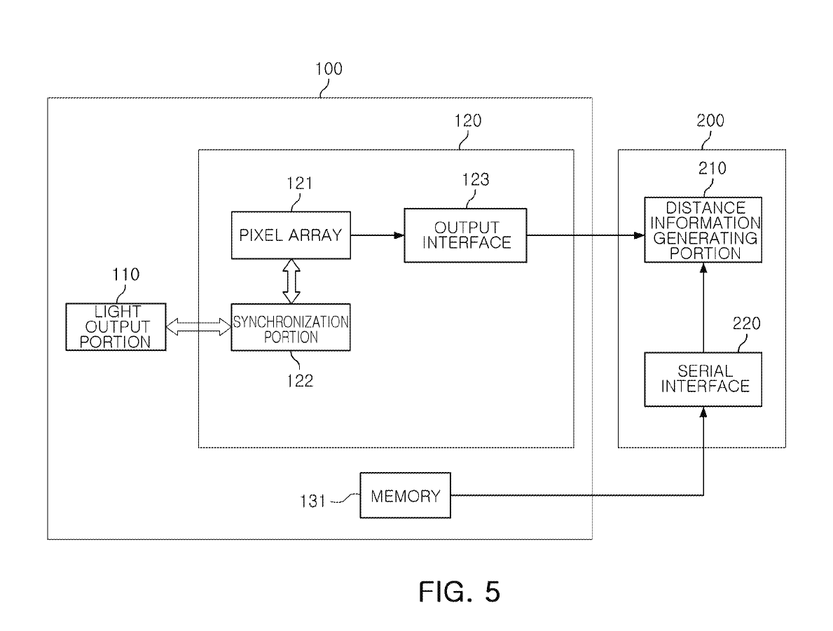

FIG. 5 is a block diagram of a main portion of an electronic device according to another exemplary embodiment.

An electronic device according to the example in FIG. 5 is the same as the electronic device in the example in FIG. 3, and thus, overlapped descriptions thereof will not be repeated, and mainly differences will be described.

Referring to FIG. 5, an image sensor 120 may include a pixel array 121, a synchronization portion 122, and an output interface 126, and a host 200 may include a distance information generating portion 210 and a serial interface 220. The distance information generating portion 210 included in the host 200 in the example in FIG. 5 may perform a function similar to the function of the distance information generating portion 123 included in the image sensor 120 in the example in FIG. 3.

The distance information generating portion 210 may receive a plurality of pixel signals of the pixel array 121, and calculate a plurality of pieces of distance information. When an application corresponding to each of modes is executed, a correction parameter included in a memory 131 may be transferred to the distance information generating portion 210 through the serial interface 220, and the distance information generating portion 210 may refer to the correction parameter. The distance information generating portion 210 may correct the plurality of pieces of distance information calculated on the basis of the correction parameter.

According to the aforementioned exemplary embodiments, a resolution of calculated distance information may be improved by changing a focal distance of an infrared camera module.

While the exemplary embodiments have been shown and described above, it will be apparent to those skilled in the art that modifications and variations could be made without departing from the scope of the present invention as defined by the appended claims.

What is claimed is:

1. An infrared camera module, comprising:
a lens configured to focus by refracting light;
a filter configured to allow a light with its wavelength in an infrared band, incident on the lens, to pass therethrough;
an image sensor configured to generate distance information to an object based on the light with its wavelength in an infrared band; and
an actuator configured to drive the lens in one direction and to adjust a focal distance of the lens.

2. The infrared camera module of claim 1, wherein the actuator adjusts a focal distance of the lens in accordance with an operational mode of the infrared camera module.

3. The infrared camera module of claim 2, wherein the operational mode of the infrared camera module is determined by a host of an electronic device in which the camera module is employed.

4. The infrared camera module of claim 1, further comprising:
a light output portion configured to irradiate the light with its wavelength in an infrared band on the object.

5. The infrared camera module of claim 3, wherein the image sensor comprises a plurality of pixels, in each of which the distance information to the object is generated, based on the light with its wavelength in an infrared band.

6. An image sensor, comprising:
a pixel array configured to receive a light with its wavelength in an infrared band; and
a distance information generating portion configured to be connected to the pixel array and to calculate distance information to an object based on the light with its wavelength in an infrared band,
wherein the distance information generating portion applies a correction parameter determined in accordance with a focal distance of a lens focusing the light to the distance information.

7. The image sensor of claim 6, further comprising:
a synchronization portion configured to synchronize an operation of a light output portion irradiating the light with its wavelength in an infrared band to the object and an operation of the pixel array.

8. The image sensor of claim 6, wherein the focal distance of the lens changes in accordance with an operational mode of an infrared camera module in which the image sensor is employed.

9. The image sensor of claim 6, wherein the pixel array comprises a plurality of pixels, and the distance information generating portion is connected to each of the plurality of pixels and generates a plurality of pieces of distance information.

10. The image sensor of claim 6, further comprising:
a SRAM configured to load the correction parameter stored in one of an EEPROM memory or OTP memory and provide the correction parameter to the distance information generating portion.

11. An electronic device, comprising:
an infrared camera module configured to include an image sensor receiving a light with its wavelength in an infrared band, and an actuator adjusting a focal distance of a lens focusing the light; and
a host configured to calculate distance information to an object based on the light with its wavelength in an infrared band.

12. The electronic device of claim 11, wherein the infrared camera module further includes a memory storing a correction parameter determined in accordance with a focal distance of the lens.

13. The electronic device of claim 12, wherein the host loads the correction parameter and applies the correction parameter to the distance information.
